(19) United States
(12) Patent Application Publication
(10) Pub. No.: US 2004/0251107 A1
(43) Pub. Date: Dec. 16, 2004

(54) Clutch housing with multi-function hydraulic sleeve

(76) Inventors: Michael C. Sefcik, Linden, MI (US); Robert F. Veldman, Brighton, MI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 10/809,032

(22) Filed: Mar. 25, 2004

Related U.S. Application Data
(60) Provisional application No. 60/457,422, filed on Mar. 25, 2003.

(51) Int. Cl. F16D 25/0638

(52) U.S. Cl. 192/85 AA; 192/106 F; 192/113.34

(57) ABSTRACT

Clutches require fluid passages to be contained therein to lubricate the moving parts therein. Current clutch designs requiring fluid passages to be formed through the spline provides numerous difficulties. The present clutch design and method of assembling the clutch comprises a clutch housing having a predetermined shape, a piston positioned within the clutch housing, a sleeve having a predetermined shape substantially conforming to the predetermined shape of the clutch housing, the sleeve being positioned within the clutch housing forming a fluid passageway between the clutch housing and the sleeve and forming a piston reactive cavity between the clutch housing, the piston, and the sleeve.

### CROSS-REFERENCE TO RELATED APPLICATIONS

This application claims priority from U.S. Provisional Patent Application No. 60/457,422 filed on Mar. 25, 2003, which is hereby incorporated by reference herein.

### FIELD OF INVENTION

The present invention relates generally to clutches, and in particular, to clutch housings with a multi-function hydraulic sleeve.

### BACKGROUND

As shown in the current design of FIG. 1, one skilled in the art will recognize the portion of the clutch housing referred to as the spline 10 having fluid passages 12, 14, and 16 positioned therein. These fluid passages 12, 14, and 16 provide fluid pressure to the piston reactive cavity 18. Such action causes engagement of the friction clutch plates 20 so that torque is transferred from the drive unit to the transmission.

It is well known, however, that the manufacture of that design is difficult for numerous reasons. Particularly, during manufacture of the spline 10, it is difficult for the fluid passages 12, 14, and 16 to hold their shape in response to the heat treatment required during manufacture. Further, the deburring steps can be difficult and costly to accomplish. Thus, the nature of the design requiring fluid passages to be formed through the spline provides numerous difficulties.

It is an object of the present invention to reduce the manufacturing complexity and reduce total cost associated with the manufacture of the clutch. The present invention will also improve the clutch by eliminating the need for intersecting holes or passages and the complex issues associated with deburring them. Further, the present invention will provide improved fluid flow into the piston reactive cavity and will provide a sealing surface so that the piston can act as a cavity seal. Finally, the present invention will provide a method of self-retention of the sleeve as well as providing a means for retaining the centrifugal compensation device.

### SUMMARY OF THE INVENTION

In accordance with the present invention there is provided a clutch that comprises: a clutch housing having a predetermined shape, a piston positioned within the clutch housing, a sleeve having a predetermined shape substantially conforming to the predetermined shape of the clutch housing, the sleeve being positioned within the clutch housing forming a fluid passageway between the clutch housing and the sleeve and forming a piston reactive cavity between the clutch housing, the piston, and the sleeve.

In accordance with the present invention there is further provided a method of assembling a clutch, comprising: providing a clutch housing having a predetermined shape, attaching a piston within said clutch housing, providing a sleeve having a shape substantially conforming to the predetermined shape of the clutch housing, and positioning the sleeve within said clutch housing such that a fluid passageway is formed between the clutch housing and the sleeve and such that a piston reactive cavity is formed between the clutch housing, the piston, and the sleeve.

The present invention will be more fully described in the following written description with reference to the accompanying drawings.

### BRIEF DESCRIPTION OF THE SEVERAL VIEWS OF THE DRAWING

Objects and advantages together with the operation of the invention may be better understood by reference to the following detailed description taken in connection with the following illustrations, wherein:

FIG. 1 is a diagrammatic cross-sectional view of the current design utilized in the art;

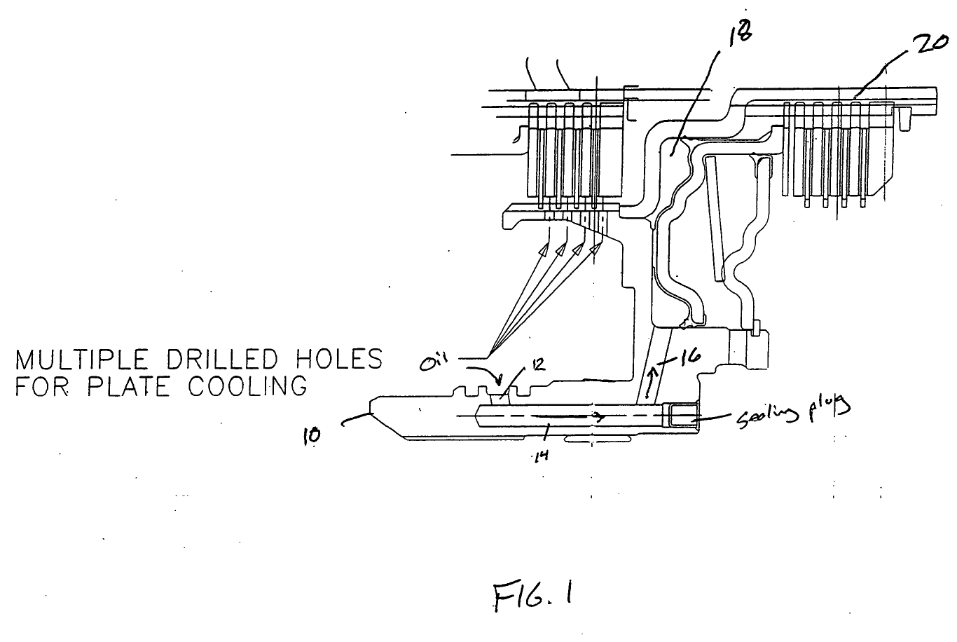

FIG. 2 is a cross-sectional view of the design of the clutch of the present invention;

FIG. 3 is a diagrammatic cross-sectional and top-half view of the design of the clutch of the present invention; and

FIG. 4 is a cross-sectional, more detailed view of the sleeve of the present invention.

### DETAILED DESCRIPTION OF THE INVENTION

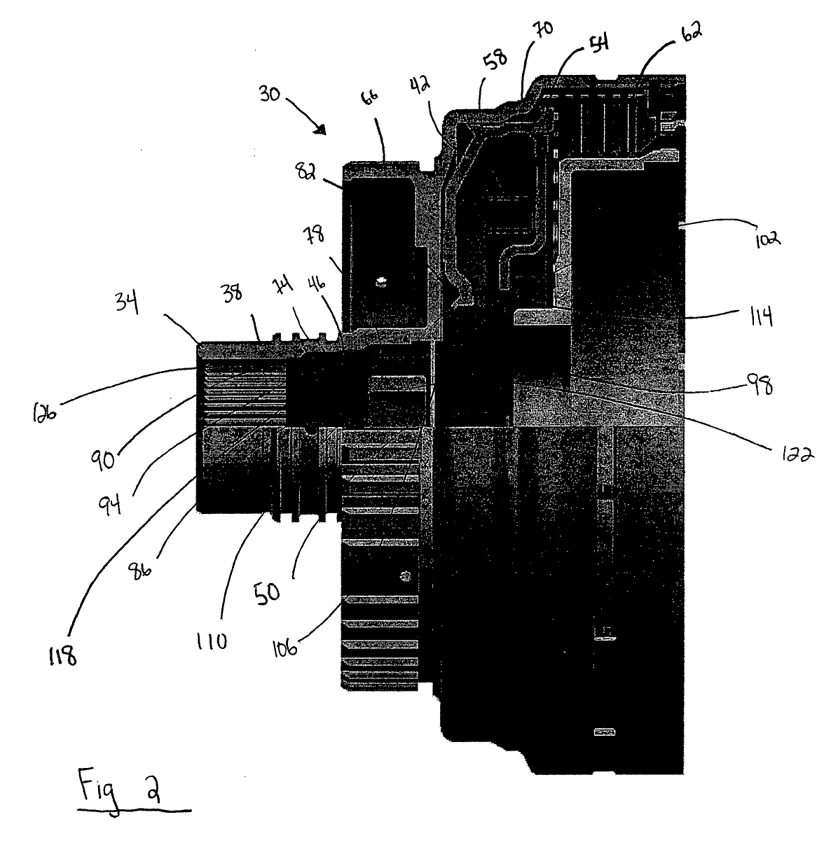

Reference is now made to the drawings to further describe the present invention, wherein like characters represent the same or corresponding parts throughout the several views. There is seen in FIG. 2 a clutch generally designated as 30. The clutch 30 includes a clutch housing 34, a portion of which is referred to as a spline 38, a piston 42, a hydraulic sleeve 46, a snap ring 50, a centrifugal compensation device 54, a set of springs 58, and friction clutch plates 62.

As can best be seen in FIG. 2, the clutch housing 34 has a predetermined shape. It has the spline 38, a first stepped portion 66, and a second stepped portion 70. The spline 38 mates with a transmission (not shown) and the second stepped portion 70 mates with an engine (not shown) in order to operate the clutch 30. Further, the spline 38 has a fluid entry passage 74 so that during operation of the clutch 30 fluid, like oil, can flow from the transmission into the clutch 30 through the fluid entry passage 74.

The sleeve 46 is positioned within the clutch housing 34. The sleeve 46 and the clutch housing 34 form a fluid passageway 78. The fluid passageway 78 permits fluid to travel from the fluid entry passage 74, through the fluid passageway 78, and into a piston reactive cavity 82, described in more detail below. More particularly, the sleeve 46 has an outer surface 86. The clutch housing 34 has an inner surface 90. The sleeve 46 is positioned within the clutch housing 34 forming a space between the outer surface 86 of the sleeve 46 and the inner surface 90 of the clutch housing 34. This space is the fluid passageway 78.

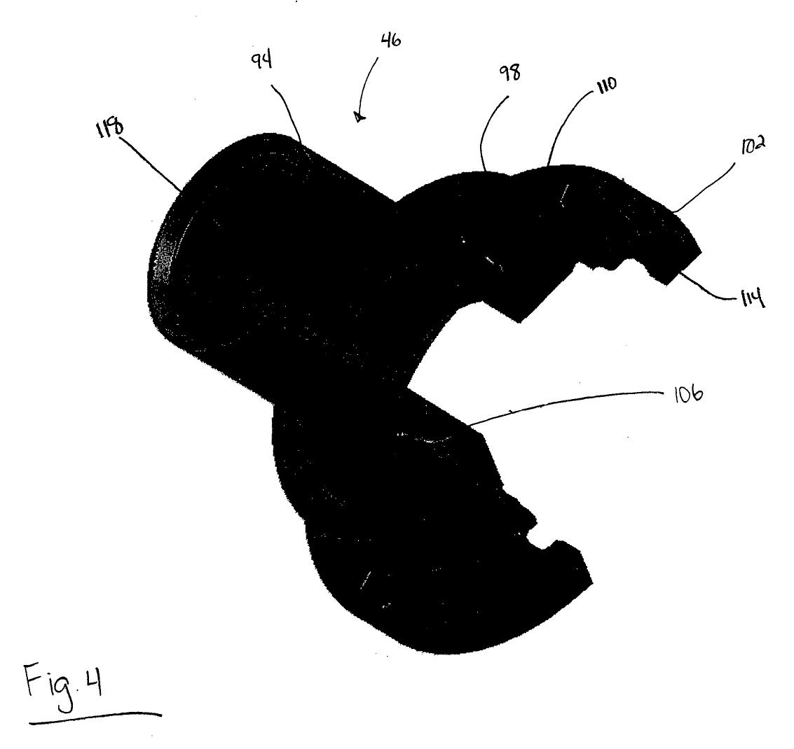

As can best be seen in FIG. 4, the sleeve 46 is generally tubular and has a predetermined shape substantially similar to the predetermined shape of the clutch housing 34. The sleeve 46 has a first portion such as a straight tubular portion 94, a first stepped portion 98, and a second stepped portion 102. The straight tubular portion 94 and the first stepped portion 98 form the fluid passageway 78 described above.

Between the tubular portion 94 and the first stepped portion 98 is a snap ring flange 106. The snap ring flange 106 holds the snap ring 50 in place. It prevents the snap ring 50 from being pushed out of place during operation of the clutch 30. The snap ring flange 106 is shaped to lock the snap ring 50 in place. The snap ring 50, when locked in the snap ring flange 106, can withstand the operational fluid pressures placed upon it during operation of the clutch 30 without falling out. The snap ring 50 itself is a fail safe. It permits the sleeve 46 to maintain its proper position within the clutch housing 34 even if the interference fit between the sleeve 46 and the clutch housing 34 is not maintained.

As stated previously, during operation of the clutch 30, fluid travels into the fluid entry passage 74, through the fluid passageway 78, and into the piston reactive cavity 82. The piston reactive cavity is formed by the clutch housing 34, the piston 42, and the sleeve 46. The first stepped portion 98 of the sleeve has a sealing surface 110 thereon. The piston 42 is in sealing engagement with the sealing surface 110, forming a portion of the piston reactive cavity 82. As discussed in more detail below, the material the sleeve 46 is composed of is sufficiently void of irregularities so that the piston 42 can create a seal with the sealing surface 110 of the sleeve 46. It is, therefore, not necessary to machine the sealing surface 110 to remove any irregularities. Further, the first stepped portion 98 and the piston 42 are positioned within the clutch housing 34 such that the piston reactive cavity 82 is formed without the necessity of drilling additional holes in the clutch housing 34.

The second stepped portion 102 of the sleeve 46 has a centrifugal retaining device 114 therein. The centrifugal retaining device 114 retains the centrifugal compensation device 54 within the clutch housing 34 during operation of the clutch 30. The centrifugal compensation device 54 helps the piston 42 remain in its proper position within the clutch housing 34 during operation of the clutch 30.

Finally, the sleeve 46 has an interior surface 118. The interior surface 118 contacts a sleeve bearing 122 that is contained within the sleeve 46. The sleeve bearing 122 absorbs the relative motion of the shaft (not shown) of the transmission (not shown). In particular, the sleeve bearing 122 is made of a softer material with lubricating fluid flowing therethrough so as to provide lubrication for the sleeve 46 and the shaft. The sleeve bearing 122 may be a separate component from the sleeve 46, or, alternatively, it may be an integral part of the sleeve 46.

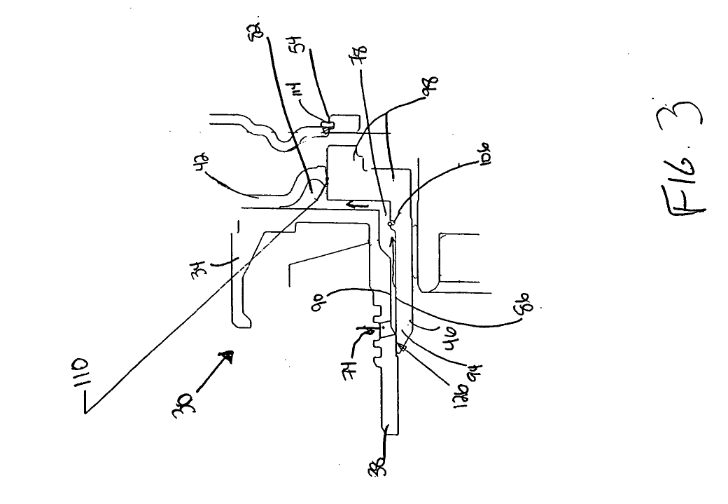

In order to assemble the clutch 30, the clutch housing 34 having the predetermined shape and a fluid entry passage 74 therein is provided. The piston 42 is then inserted into the clutch housing 34 and is attached thereto. The sleeve 46 is then positioned within the clutch housing 34 so that the outer surface 86 of the sleeve 46 is below the inner surface 90 of the clutch housing 34 forming the fluid passageway 78. The sleeve 46 is positioned within the clutch housing 34 until it is sealingly engaged with the clutch housing 34 by an interference fit thereby providing a sleeve retaining feature interference fit 126 as is best seen in FIG. 3.

Further, the first stepped portion 98 of the sleeve 46 is positioned relative to the piston 42 and the clutch housing 34 so as to form the piston reactive cavity 82. The contact of the piston 42 and the sealing surface 110 of the first stepped portion 98 creates the seal for the piston reactive cavity 82 substantially sealing fluid therein. The sealing surface 110 and the piston 42 are substantially sealed without the necessity of machining the sealing surface 110 due primarily to the composition of the sleeve 46.

The sleeve 46 is composed of a powered metal material such as sintered iron. It should be understood, however, that the composition of the sleeve 46 is not limited to powered metal, but may also include other materials such as aluminum, steel, ceramic, etc. The sleeve 46 being composed of powered metal causes the sealing surface 110 to be void of irregularities and as such creates an excellent sealing surface. Further, the sleeve 46 being composed of powered metal makes it unnecessary to machine the sealing surface 110. Reducing the manufacturing and assembly costs of the clutch 30.

Thus, through the current design, the present invention eliminates two sets of three intersecting holes and a sealing plug. Further, the sleeve 46 of the present invention can improve the fluid flow to the piston reactive cavity 82 because the fluid no longer needs to flow through a machined passageway.

The invention has been described above and, obviously, modifications and alternations will occur to others upon a reading and understanding of this specification. In addition, the method of assembly described above is not limited to the order in which the steps above are recited. The claims as follows are intended to include all modifications and alterations insofar as they come within the scope of the claims or the equivalent thereof.

Having thus described the invention, I claim:

1. A clutch, comprising:
a clutch housing having a predetermined shape;
a piston positioned within the clutch housing; and
a sleeve having a predetermined shape substantially conforming to the predetermined shape of the clutch housing, the sleeve being positioned within the clutch housing forming a fluid passageway between the clutch housing and the sleeve and forming a piston reactive cavity between the clutch housing, the piston, and the sleeve.

2. The clutch of claim 1, wherein the sleeve is sealingly engaged with the clutch housing by an interference fit between the sleeve and the clutch housing.

3. The clutch of claim 1, wherein the predetermined shape of the sleeve has a first portion, a first stepped portion, and a second stepped portion.

4. The clutch of claim 1, wherein the clutch housing further includes a fluid entry passage therein such that during operation of the clutch fluid travels into the fluid entry passage and through the fluid passageway and into the piston reactive cavity.

5. The clutch of claim 1, wherein the sleeve is made from a powered metal material.

6. The clutch of claim 5, wherein the powered metal material is sintered iron.

7. The clutch of claim 1, wherein the sleeve has a sealing surface thereon in sealing engagement with the piston so that the piston substantially seals the piston reactive cavity.

8. The clutch of claim 1, further comprising a centrifugal compensation device positioned within the clutch housing wherein the sleeve has a centrifugal retaining device therein to retain the centrifugal compensation device within the clutch housing.

9. A clutch, comprising:
a clutch housing;
a piston positioned within the clutch housing; and
a sleeve having a stepped portion, the sleeve being positioned within the clutch housing such that a fluid passageway is formed between the clutch housing and the sleeve and such that the piston is in sealing engagement with the stepped portion of the sleeve forming a piston reactive cavity between the clutch housing, the piston, and the sleeve.

10. The clutch of claim 9, wherein the clutch housing further includes a fluid entry passage therein such that during operation of the clutch fluid travels into the fluid entry passage and through the fluid passageway and into the piston reactive cavity.

11. A method of assembling a clutch, the method comprising:
providing a clutch housing having a predetermined shape;
attaching a piston within said clutch housing;
providing a sleeve having a shape substantially conforming to the predetermined shape of the clutch housing; and
positioning the sleeve within said clutch housing such that a fluid passageway is formed between the clutch housing and the sleeve and such that a piston reactive cavity is formed between the clutch housing, the piston, and the sleeve.

12. The method of claim 11, further comprising creating a fluid entry passage in the clutch housing so that during operation of the clutch fluid travels into the fluid entry passage and through the fluid passageway and into the piston reactive cavity.

13. The method of claim 11, further comprising:
providing a sealing surface on the sleeve; and
positioning the piston in sealing engagement with the sealing surface of the sleeve substantially sealing the piston reactive cavity.

14. The method of claim 11, wherein the sleeve is made from a powered metal material.

15. The method of claim 14, wherein the powered metal material is sintered iron.

16. A method of assembling a clutch, the method comprising:
providing a clutch housing;
attaching a piston within the clutch housing;
providing a sleeve having at least one stepped portion, the stepped portion having a sealing surface thereon;
positioning the sleeve within the clutch housing such that a fluid passageway is formed between the clutch housing; and
forming a seal between the piston and the sealing surface on the sleeve so as to form a piston reactive cavity between the clutch housing, the piston, and the sleeve.

17. The method of claim 16, further comprising creating a fluid entry passage in the clutch housing so that during operation of the clutch fluid travels into the fluid entry passage and through the fluid passageway and into the piston reactive cavity.
